(19) United States
(12) Patent Application Publication
(10) Pub. No.: US 2006/0157985 A1
(43) Pub. Date: Jul. 20, 2006

(54) Drain tube sections with connectors therefor

(76) Inventors: Donald E. Dahowski, York, PA (US); James G. Wilson, Lancaster, PA (US)

Correspondence Address: NIXON PEABODY, LLP, 401 9TH STREET, NW, SUITE 900, WASHINGTON, DC, 20004-2128, US

(21) Appl. No.: 11/316,349

(22) Filed: Dec. 23, 2005

Related U.S. Application Data
(60) Provisional application No. 60/641,077, filed on Jan. 4, 2005.

(51) Int. Cl. F16L 23/00

(52) U.S. Cl. 285/405

(57) ABSTRACT

A modular drain system and connector therefor, the drain system including drain tube sections with a body having side walls that extend upwardly, and a connector partially received in each of the drain tube sections to interconnect the drain tube sections together. The connector has a base, and at least one extending flange that extends at least partially upwardly from the base of the connector. The extending flange contacts at least one of the side walls of the drain tube sections at an angle to a vertical axis of the connector to minimize relative movement. The extending flange of one embodiment is biased outwardly against the side walls of the drain tube sections. The extending flange may be implemented as a planar funnel that opens to an access channel.

This application claims priority to U.S. Provisional Application No. 60/641,077, filed Jan. 4, 2005, the contents of which are incorporated herein by reference.

### BACKGROUND OF THE INVENTION

1. Field of the Invention

The present invention is directed to connectors for interconnecting drain tube sections, and drain tube sections that utilize such connectors. In particular, the present invention is directed to connectors for interconnecting, and preventing rotation of, the interconnected drain tube sections.

2. Description of Related Art

Various designs of drain tube sections are used in industry. For example, drain tube sections are utilized around the periphery of a swimming pool for carrying the surface water away to a drain. In such applications, drain tube sections are typically installed into a concrete deck or the like, the top of the drain tube sections being substantially flush with the top surface of the deck formed by the concrete. The top of the drain tube sections typically have openings that are open to the deck surface so as to allow water to be received into the drain tube sections. The openings that are provided on top of the drain tube sections may be slotted holes.

For example, U.S. Pat. No. 6,612,780 to Dahowski et al. discloses a modular trench drain system including a plurality of drain tube sections that are interconnected by connectors with a semi-circular base. One portion of the connector is partially received within one drain tube section, and another portion of the connector is partially received within an adjacent drain tube section. The connectors in this reference are disclosed as having a substantially C-shaped cross section in one embodiment, and a D-shaped cross section in another embodiment.

U.S. Pat. No. 4,815,888 to Stegmeier discloses a swimming pool drain including a plurality of drain tube sections that are interconnected by connectors. The reference also discloses that the connectors have a semi-circular base and a boxed section connected thereto. One portion of the connector is partially received within one drain tube section, and another portion of the connector is partially received within an adjacent drain tube section, thereby interconnecting two adjacent drain tube sections.

However, more commonly used drain tube sections typically utilize simple, tubular connectors that have a circular cross section. For example, U.S. Pat. No. 6,729,795 to Dahowski et al. discloses a modular drain and drain system including a plurality of drain tube sections that are interconnected by tubular connectors, one portion of which is partially received within one drain tube section, and another portion of which is partially received within an adjacent drain tube section.

Such connectors are typically partially installed in one drain tube section to protrude therefrom, and the protruding portion of the connector is installed in an adjacent drain tube section to thereby interconnect adjacently positioned drain tube sections, end to end. The interconnected drain tube sections provide a continuous flow channel for conveying the water to the drain. Most installers that install drain tube sections use glue or other adhesives to bond the connector to the drain tube sections thereby forming a joint. In certain instances, the installer may elect not to adhere the connector directly to the drain tube section. However, as discussed in detail below, installing conventional drain tube sections with tubular connectors, without using glue or other adhesives can cause problems.

### SUMMARY OF THE INVENTION

When the installer elects not to bond the joint between the connector and the drain tube sections with an adhesive, the interconnected drain tube sections can rotate relative to one another during the installation process. For example, the interconnected drain tube sections can rotate during construction of the concrete deck as concrete is poured along a side of one drain tube section, but not simultaneously poured along a side of the interconnected drain tube section.

This described problem is illustrated in FIGS. 6A and 6B which show end views of example drain tube sections disclosed in U.S. Pat. No. 6,729,795, and a conventional, tubular connector received therein that interconnects two adjacent drain tube sections. In particular, FIG. 6A shows a drain tube section 100, and a connector 110 partially received in the drain tube section 100. The connector 110 is installed so as to protrude out from the end of the drain tube section 100, and be received in an adjacent drain tube section (shown in FIG. 6B), thereby interconnecting the two adjacent drain tube sections together, end to end.

When the connector 110 is not adhered to the interconnected drain tube sections, one or more of the interconnected drain tube sections can be rotated relative to each other. This is most clearly shown in FIG. 6B in which drain tube section 100 is interconnected to drain tube section 104 by the connector 110. As shown, the drain tube section 104 (as well as drain tube section 100) can be rotated about the connector 110 relative to each other so that the two interconnected drain tube sections are no longer aligned. This poses installation difficulties and can result in expensive repair if, for example, the misalignment of the interconnected drain tube sections is not detected, and the poured concrete is allowed to cure when the drain tube sections are in such misaligned arrangement.

Whereas the C-shaped and D-shaped connectors disclosed in U.S. Pat. No. 6,612,780 to Dahowski et al. and U.S. Pat. No. 4,815,888 to Stegmeier would prevent gross misalignment of the interconnected drain tube sections, because of the surface to surface contact between the connector and the walls of the drain tube sections and the deflection of the connector walls, resistance to small misalignment between the interconnected drain tube sections is small.

Therefore, there exists a need for connectors that resist misalignment of interconnected drain tube sections, and provide a stable connection, even if adhesives are not used.

In view of the foregoing, an advantage of the present invention is in providing a connector for interconnecting drain tube sections.

Another advantage of the present invention is in providing such a connector that prevents misalignment of the interconnected drain tube sections, and further provide a stable connection when adhesives are not used.

In accordance with one aspect of the present invention, a modular drain system is provided which includes at least two drain tube sections, each having a main body with a main channel for conveying a liquid, the main body including side walls that extend at least partially upwardly. The modular drain system also includes a connector at least partially received in each of the drain tube sections to interconnect the drain tube sections together and allow the liquid to be conveyed therebetween. The connector has a base, at least a portion of the base including at least an arcuate cross section, and at least one extending flange that extends at least partially upwardly from the base of the connector. The extending flange contacts at least one of the side walls of at least one of the drain tube sections at an angle to a vertical axis of the connector to minimize relative movement between the drain tube sections.

In accordance with another embodiment, the at least one extending flange includes a pair of extending flanges that extends upwardly from the edges of the base to contact the side walls of each of the drain tube sections at an angle to the vertical axis of the connector. In one embodiment, the pair of extending flanges may be dimensioned to require displacement thereof in order to be at least partially received in the drain tube sections. In this regard, the pair of extending flanges is biased outwardly against the side walls of each of the at least two drain tube sections.

In accordance with still another embodiment, the connector includes an access channel to allow the liquid to enter into the base of the connector from a top of the connector. In such an embodiment, the pair of flanges may be positioned to form a planar funnel that is open to the access channel.

In accordance with yet another embodiment of the present invention, the modular drain system includes at least two drain tube sections, each having a main body with a main channel for conveying a liquid, the main body including side walls that extend at least partially upwardly. The modular drain system also includes a connector at least partially received in each of the at least two drain tube sections to interconnect the drain tube sections together, and allow the liquid to be conveyed therebetween. The connector has a base, an access channel to allow the liquid to enter into the base of the connector from a top of the connector, and at least a pair of flanges that extend upwardly from the base at an angle to a vertical axis of the connector, to form a planar funnel open to the access channel.

In yet another embodiment, the modular drain system includes at least two drain tube sections, each having a main body with a main channel for conveying a liquid, the main body including side walls that extend at least partially upwardly. The modular drain system also includes a connector at least partially received in each of the at least two drain tube sections to interconnect the drain tube sections together and allow the liquid to be conveyed therebetween, the connector having a base and at least one extending flange that extends upwardly from the base, and is dimensioned to be displaced when at least partially received in the drain tube sections. In an alternative embodiment, the extending flange is a pair of extending flanges which are displaced to bias outwardly against the side walls of each of the two drain tube sections.

In accordance with another aspect of the present invention, a connector for interconnecting drain tube sections together is provided, the connector including a base, at least a portion of the base including at least an arcuate cross section, and at least one extending flange that extends upwardly from the base at an angle to a vertical axis of the connector to contact a side wall of a drain tube section to resist relative rotation of interconnected drain tube sections.

In another embodiment, the at least one extending flange is a pair of flanges that extend upwardly from the base at an angle to the vertical axis of the connector to contact the side walls of the drain tube sections. In another implementation, the pair of flanges may be dimensioned to require displacement in order to be at least partially received in the drain tube sections. Moreover, the connector may be implemented in other embodiments to include an access channel to allow the liquid to enter into the base of the connector from a top of the connector. In such an embodiment, the pair of flanges are positioned to form a planar funnel open to the access channel.

In still another embodiment, the connector may include a base, an access channel to allow the liquid to enter into the base of the connector from a top of the connector, and at least a pair of flanges that extend upwardly from edges of the base at an angle to a vertical axis of the connector to form a planar funnel open to the access channel.

In accordance with still another aspect of the present invention, a method for assembling a modular drain system is provided, the method including providing a connector having a base and at least one extending flange that extends at least partially upwardly from the base, at least a portion of the base including at least an arcuate cross section. The method also includes partially inserting the connector in one end of a first drain tube section so that at least a portion of the connector protrudes from the first drain tube section, and inserting the protruding portion of the connector in one end of a second drain tube section so as to interconnect the first and second drain tube sections together. In accordance with the present method, relative movement between the first and second drain tube sections is restricted by the at least one extending flange which contacts at least one of the side walls of the first and second drain tube sections at an angle to a vertical axis of the connector.

In accordance with another embodiment, the method for assembling a modular drain system includes providing a connector having a base and a pair of extending flanges that extends at least partially upwardly from the base, displacing at least a portion of the pair of extending flanges of the connector, and partially inserting the connector in one end of a first drain tube section with at least a portion of the pair of extending flanges displaced, at least a portion of the connector protruding from the one end of the first drain tube section. The method further includes inserting the protruding portion of the connector in one end of a second drain tube section so as to interconnect the first and second drain tube sections together. The pair of extending flanges partially received in the first drain tube section are preferably displaced to bias outwardly against side walls of the first drain tube section.

In another embodiment, the method may further include displacing the portion of the pair of extending flanges of the connector that protrudes from the first drain tube section before insertion into the second drain tube section. The pair of extending flanges may be displaced to bias outwardly against side walls of the first and second drain tube sections in still another implementation of the present method.

In accordance with yet another embodiment of the present invention, the method for assembling a modular drain system includes providing a connector having a base, an access channel to allow the liquid to enter into the base of the connector from a top of the connector, and a pair of extending flanges that extends at least partially upwardly from the base at an angle to a vertical axis of the connector to form a planar funnel into the access channel. The method also includes partially inserting the connector in one end of a first drain tube section so that at least a portion of the connector protrudes from the first drain tube section, and inserting the protruding portion of the connector in one end of a second drain tube section so as to interconnect the first and second drain tube sections together.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1A shows a perspective view of a connector in accordance with one example embodiment of the present invention.

FIG. 1B shows an end view of the connector of FIG. 1A.

FIG. 1C illustrates the connector of FIG. 1A installed in an example drain tube section.

FIG. 2 shows a perspective view of a connector in accordance with another example embodiment of the present invention.

FIG. 3 shows the connector of FIG. 1A installed in another example drain tube section.

FIG. 4A shows an end view of a connector in accordance with another embodiment of the present invention.

FIG. 4B shows the connector of FIG. 4A installed in an example drain tube section.

FIG. 5A shows an end view of a connector in accordance with yet another embodiment of the present invention.

FIG. 5B shows the connector shown in FIG. 5A installed in an example drain tube section.

FIG. 6A shows a conventional connector installed in an example drain tube section.

FIG. 6B shows the misalignment of two adjacent, interconnected drain tube sections which can occur when conventional connectors are used.

### DETAILED DESCRIPTION OF THE PREFERRED EMBODIMENT

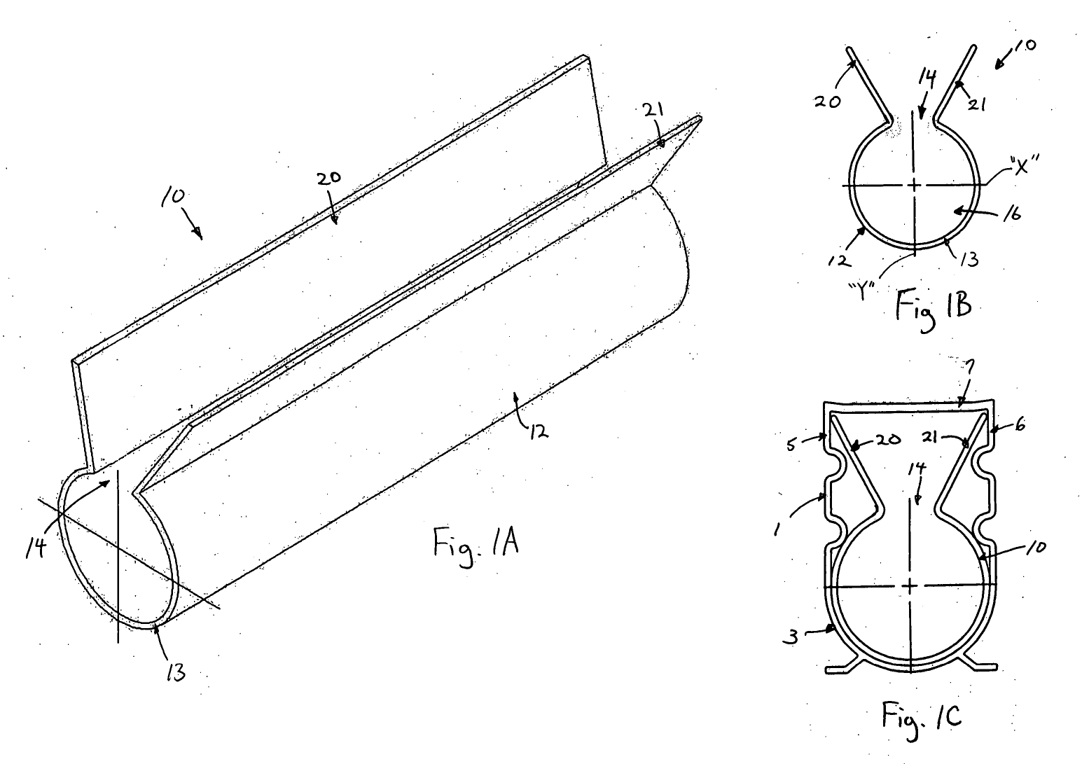

FIG. 1A shows a perspective view of a connector in accordance with one example implementation of the present invention. The connector 10 includes a main body 12 that has a base 13, the base 13 including a main channel 16 for conveying liquid through the connector 10 as most clearly shown in the end view of FIG. 1B. In the illustrated embodiment, the base 13 of the main body 12 has an arcuate cross section as shown in FIG. 1B. In particular, in this embodiment, the base 13 is almost circular in cross section so that the main body 12 extends approximately 315° of a circle. Preferably, the base 13 of the main body has at least a semi-circular cross section, i.e. the main body extends at least 180° of a circle. Of course, the cross-sectional shape of the connector 10 shown is merely provided as an example, and in other embodiments, the base may have a differently shaped cross section, or the arcuate cross section may extend a different angle than that described. However, the almost circular cross sectional shape of the base 13 allows the connector 10 to be utilized with various drain tube sections presently available and used in the art as described in further detail below.

In the illustrated embodiment, the main body 12 is discontinuous in that an access channel 14 is provided on top of the main body 12. In the illustrated embodiment, the access channel 14 extends the length of the connector 10. The access channel 14 provides access to the main channel 16 in the main body 12 so that water can flow from the deck surface, through the access channel 14, and into the main channel 16 of the connector 10.

In addition, as also shown in these figures, the connector 10 includes an alignment mechanism, which in the illustrated embodiment, is implemented as extending flanges 20 and 21. The extending flanges 20 and 21 extends at least partially upwardly from the base 13 of the connector 10 at an angle to a vertical axis “Y” of the connector 10 as clearly shown in FIG. 1B. In this regard, in the illustrated embodiment, the flanges 20 and 21 extend from base 13 at the edges of the access channel 14. Moreover, the flanges 20 and 21 extend both upwardly along the direction of the vertical axis “Y”, and outwardly along the direction of a horizontal axis “X”. Thus, the flanges 20 and 21 flare upwardly and outwardly from the base 13 of the connector.

As can also be appreciated by examination of both FIGS. 1A and 1B, the flanges 20 and 21 function as a planar funnel to direct the liquid into the main channel 16 of the connector 10. Moreover, as described in further detail below, the extending flanges are preferably sized to contact the side walls of at least one of the drain tube sections to minimize relative movement between the drain tube sections.

It should be noted that whereas in the illustrated embodiment, the flanges 20 and 21 extend the full axial length of the main body 12 of the connector 10, in other embodiments, the flanges and/or main body may be implemented differently so that the flanges extend only a partial axial length of the main body, or even extend beyond the main body. However, the illustrated embodiment is preferred since it reduces the manufacturing costs by reducing additional processing steps associated with providing flanges having an axial length different than that of the main body 12. In this regard, the extending flanges 20 and 21 are preferably integrally formed with the main body 12 of the connector 10 as shown in the illustrated embodiment. However, although less preferred, the flanges may be fixedly attached to the main body in other implementations.

FIG. 1C illustrates the connector 10 shown in FIGS. 1A and 1B in use, the connector 10 being installed in a conventional drain tube section 1 for illustrative purposes. The drain tube section 1 includes a plurality of slotted openings at the upper surface 7 as known in the art, for allowing the water to enter into the drain tube section 1. The water is the conveyed in the lower portion 3 of the drain tube section 1 in a conventional manner to a drain.

As can be seen in FIG. 1C, the main body 12 of the connector 10 is sized to be received in the drain tube section 1. In this regard, the arcuate shape of the base 13 substantially corresponds to the shape of the lower portion 3 of the drain tube section 1 when the connector 10 is installed in the drain tube section 1. The flanges 20 and 21 extend upwardly and outwardly from the main body 12 of the connector 10. When installed, the flanges 20 and 21 contact the side walls 5 and 6 of the drain tube section 1, respectively, at an angle as clearly shown in FIG. 1C. In this regard, in the illustrated embodiment, the flanges 20 and 21 contact the side walls 5 and 6 at an acute angle.

In accordance with the present invention, because the connector 10 is provided with flanges 20 and 21 that extend upwardly and outwardly to abut the side walls 5 and 6 of the drain tube section 1, the connector 10 resists relative rotation between interconnected drain tube sections. In particular, when the connector 10 is partially inserted into an end of one drain tube section, and the protruding portion of the connector 10 is inserted into an adjacent drain tube section to thereby interconnect the two adjacent drain tube sections together, the flanges 20 and 21 of the connector 10 resist axial rotation of the adjacent drain tube sections relative to one another by contacting the side walls of the drain tube sections as described. Moreover, the flanges 20 and 21 enhance this resistance to misalignment by contacting the side walls of the drain tube section at an angle as also noted. Thus, because the flanges 20 and 21 resists misalignment of the drain tube sections relative to each other, the situation illustrated and discussed above relative to FIG. 6B is prevented from occurring between adjacent drain tube sections that are interconnected by the connector 10 in the manner shown in FIG. 1C.

Preferably, the connector 10 is implemented so that the pair of extending flanges 20 and 21 are dimensioned to require displacement in order to be partially received in the drain tube sections. As used herein, the term “displacement” means moving of the extending flanges 20 and 21, whether by actual deflection of the extending flanges 20 and 21, by resilient spring compression (reduction in diameter) of the base 13 of the connector 10 by virtue of the C-shaped of the base 13, or combination of both. Correspondingly, in such an embodiment as applied to the illustrated implementation of FIG. 1C, the pair of extending flanges 20 and 21 are biased outwardly against the side walls 5 and 6 of the drain tube section 1 with a spring force by the action of the displaced extending flanges 20 and 21 by the virtue of deflection of the extending flange and/or compression of the base. This biasing force further resists relative movement between two interconnected drain tube sections, above and beyond the resistance provided by the virtue of the flanges 20 and 21 contacting the side walls of the drain tube section 1. It has been found that by providing the connector 10 as described in which the extending flanges 20 and 21 contact the side walls 5 and 6 of the drain tube section at an angle, and are also biased against the side walls by virtue of a spring force, incidences of relative movement between the interconnected drain tube sections can be substantially eliminated.

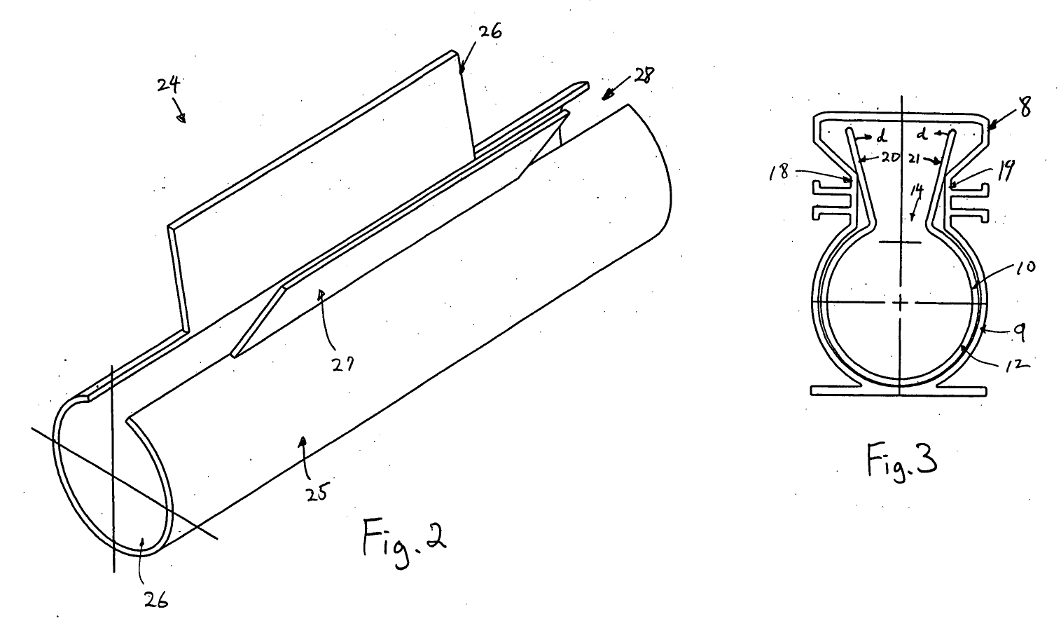

FIG. 2 shows a perspective view of a connector 24 in accordance with another example implementation of the present invention. The connector 24 is substantially similar to connector 10 discussed above relative to FIGS. 1A to 1C, and includes a main body 25 with an access channel 28 for allowing fluid to enter into the main channel 26. The connector 24 also includes an alignment mechanism, which in the illustrated embodiment, is implemented as flanges 26 and 27 that are attached to the edges of the main body 25, and extend upwardly and outwardly therefrom. However, in contrast to the connector 10 discussed above, the flanges 26 and 27 of connector 24 extend only a partial length of the main body 25.

The connector 24 operates in a manner similar to the above described connector 10. However, because the flanges 26 and 27 of connector 24 extend only a partial length of the main body 25, the connector 24 can be readily be used to install end caps, other fittings, or additional tubing, at one end thereof as desired, depending on the configuration of the drainage system being installed. The connector 10 shown in FIG. 1A can be modified on the field so that the flanges 20 and 21 extend only a partial length as provided in connector 24 by cutting a portion of the flanges off the connector 10. However, such cutting can be avoided by providing the connectors 24 described. Thus, the connector 24 facilitates installation of a drainage system in accordance with a desired configuration.

FIG. 3 shows the connector 10 discussed above relative to FIG. 1A which has been installed to interconnect another drain tube section 8 that is known in the prior art and commercially available. As shown, the main body 12 is received in the base 9 of the drain tube section 8. The flanges 20 and 21 extend outwardly from the main body 12, and that the connector 10 is provided with an access channel 14 so that the main body 12 is C-shaped. As can be seen, the connector 10, which is provided with the access channel 14, allows the flanges 20 and 21 to be displaced inwardly in the direction of arrows “d” so as to allow the connector 10 to be fit within the drain tube section 8. Correspondingly, the pair of extending flanges 20 and 21 contact side walls 18 and 19 of the drain tube section 8 at an angle, and are biased outwardly against the side walls 18 and 19 with a spring force by the action of the deflected extending flanges 20 and 21 and/or compression of the base as previously described in detail. Again, this biasing force further resists relative movement between two interconnected drain tube sections, above and beyond that provided by the virtue of the flanges 20 and 21 contacting the side walls of the drain tube section 8, so that resistance to misalignment of interconnected drain tube sections is enhanced.

In the application shown in FIG. 3, the described displacement of the flanges 20 and 21 is especially advantageous in that the side walls 18 and 19 of the drain tube section 8 is necked inwardly toward the center of the drain tube section 8. Correspondingly, the allowance of such displacement allows the connector 10 of the illustrated embodiment to be used with a variety of different drain tube sections that are commercially available, only two of which are shown in FIGS. 1C and 3. Thus, in the same manner as described relative to FIG. 1C, the connector 10 prevents interconnected drain tube sections 8 from rotating with respect to each other so as to prevent misalignment of the interconnected drain tube sections during installation.

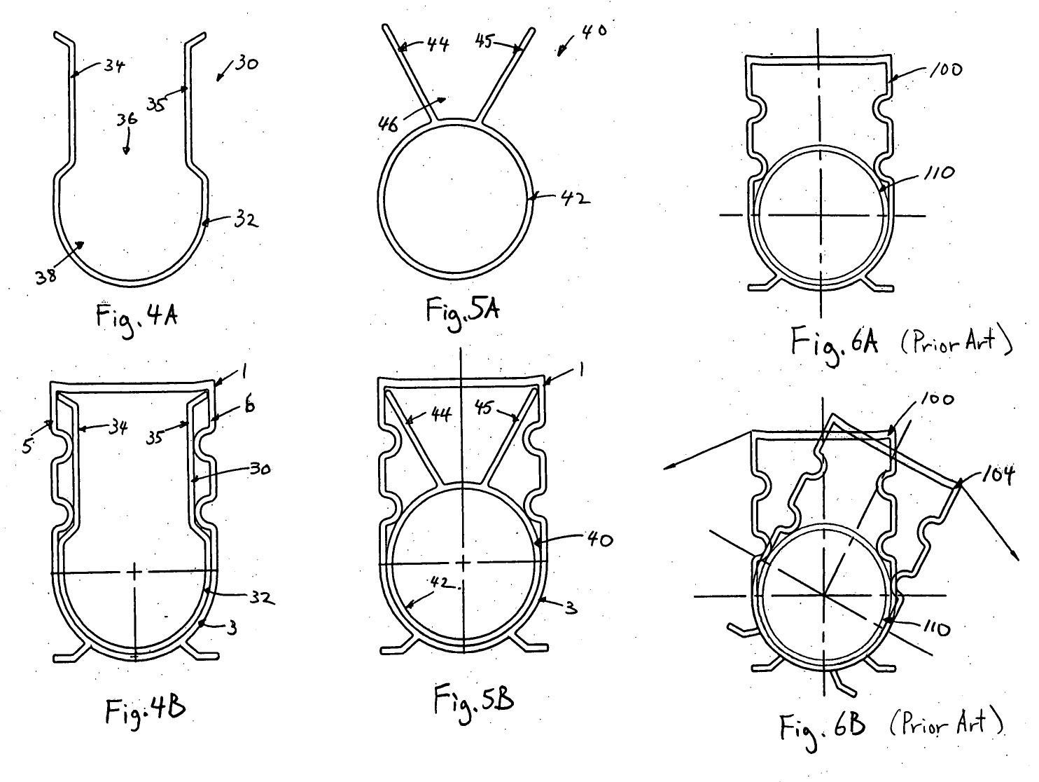

FIG. 4A shows an end view of a connector 30 in accordance with another embodiment of the present invention. As shown, the connector 30 includes a main body 32, and flanges 34 and 35 extending upwardly and outwardly from the main body 32. The flanges 34 are 35 are preferably integrally formed with the main body 32 of the connector 30, although other in other implementation, the flanges may be attached to the main body 32. As shown in FIG. 4A, the connector 30 is also provided with an access channel 36 to allow water to flow into the main channel 38 of the connector 30.

The connector 30 as shown in FIG. 4A operates in a similar manner to the previously described embodiment shown in FIGS. 1A and 1B. Correspondingly, as shown in FIG. 4B, the connector 30 is partially received in a drain tube section 1 with the main body 32 being received in the lower portion 3 of the drain tube section 1. The flanges 34 and 35 are sized so that the connector 30 can be received within the drain tube section 1, the flanges 34 and 35 extending upwardly and outwardly to contact the side walls 5 and 6 of the drain tube section 1. Moreover, the flanges 34 and 35 may be implanted to require displacement thereof for installation into the drain tube section in other embodiments so that the flanges are biased against the side walls of the drain tube section in the manner previously described.

The portion of the connector 30 that protrudes from the drain tube section 1 is received in an adjacent drain tube section so that the two drain tube sections are interconnected together. As can be appreciated, in the illustrated embodiment, the flanges 34 and 35 extend substantially more upwardly than outwardly. Correspondingly, the above described funnel feature is not provided by the connector 30 as shown in FIGS. 4A and 4B. Nonetheless, the flanges 34 and 35 extend to contact the side walls 5 and 6 of the drain tube section 1 at an angle as most clearly shown in FIG. 4B. Thus, the connector 30, when used to interconnect two adjacent drain tube sections 1 together, resists relative rotation between the interconnected drain tube sections so that incidences of misalignment is minimized.

FIG. 5A shows an end view of a connector 40 in accordance with still another embodiment of the present invention. As can be seen, connector 40 is somewhat similar to connector 10 discussed above relative to FIGS. 1A and 1B. However, connector 40 is not provided with an access channel. Instead, the connector 40 includes a main body 42 which is substantially tubular and enclosed, the flanges 44 and 45 extending from the main body 42. In this regard, the flanges 44 and 45 are preferably integrally formed with the main body 42.

In the manner previously described relative to the other embodiments, the flanges 44 and 45 are sized to contact the side walls of interconnected drain tube sections at an angle, for example, in the manner shown in FIG. 5B. Correspondingly, the connector 40 can be used to interconnect two adjacent drain tube sections 1 while also resisting relative rotation between the interconnected drain tube sections so that misalignment during installation does not occur, even when adhesives are not used to secure the connector 40 to the drain tube section 1.

It should be noted that in the present embodiment, because an access channel is not provided in connector 40, the water that enters through the drain tube section at the interconnection immediately above the connector 40 must be conveyed in the channel 46 formed between the flanges 44 and 45, until it reaches the end of the connector 40 to enter the lower portion 3 of the drain tube section 1. Of course, in other embodiments, slots or other openings may be provided on the top of the main body 42 between the flanges to allow the liquid to enter the main body 42.

In addition, it should also be noted that even though an access channel is not provided in the connector 40, the flanges 44 and 45 may still be dimensioned to require displacement in order to be installed in the drain tube section 1. In this regard, the connector 40 and/or flanges 44 and 45 may be formed in various embodiments using a somewhat deflectable material so that the flanges 44 and 45 are biased against the side walls of the drain tube section when installed.

It should be noted that while not required, the above described connectors in accordance with the present invention are preferably utilized together with an adhesive so that a leak resistant connection is established between the interconnected drain tube sections. However, as noted, even if such adhesive is not used for whatever reason, the connector in accordance with the present invention resists misalignment of the interconnected drain tube sections, and provides a stable connection of the drain tube sections. Moreover, the connectors of the present invention may be made of any appropriate material such as PVC, nylon, plastics, etc. Furthermore, the connectors may be manufactured in any appropriate manner such as by molding, extrusion, etc.

It should further be evident that whereas the preferred implementations of the connectors have been illustrated and discussed above, the connectors of the present invention may be implemented with different shapes, depending on the drain tube sections for which the connectors are used. However, the configuration of the connectors as described above, especially in relation to the embodiment of FIG. 1A has been found to be especially advantageous in that it may be used in conjunction with drain tube sections of different shapes that are already commercially available.

In the above regard, the connectors may be sized with dimensions based on the size and dimension of the drain tube sections, so that the connectors can be used in the manner described above. For example, the main body of the connectors may be approximately two inches, in width, and have a total height dimension of approximately three inches for use in two inch width drain tube sections that are presently commercially available.

Moreover, as discussed above, the connector of the present invention may be implemented so that the flanges have to be displaced in order to be inserted into the drain tube sections. This requirement would cause an outward expansion spring force described above that is exerted on the side walls of the drain tube section in which the connectors are installed. Such spring force further ensures that the interconnected drain tube sections do not rotate with respect to each other, above and beyond resistance to such rotation that is provided by the virtue of the flanges contacting the side walls of the drain tube section. Of course, the connectors can be shaped and sized so that the appropriate desired amount of displacement of the flanges is required for installation.

In view of the above, it should also be apparent that another aspect of the present invention is in providing a method for assembling a modular drain system. In one embodiment, the method includes providing a connector having a base and at least one extending flange that extends at least partially upwardly from the base, the base including at least an arcuate cross section. The method also includes partially inserting the connector in one end of a first drain tube section so that a portion of the connector protrudes from the first drain tube section, and inserting the protruding portion of the connector in one end of a second drain tube section so as to interconnect the first and second drain tube sections together. In accordance with the present method, relative movement between the first and second drain tube sections is restricted by the extending flange which contacts at least one of the side walls of the first and second drain tube sections at an angle to a vertical axis of the connector.

In accordance with another embodiment, the method for assembling a modular drain system includes providing a connector having a base and a pair of extending flanges that extends at least partially upwardly from the base, displacing at least a portion of the pair of extending flanges of the connector, and partially inserting the connector in one end of a first drain tube section with at least a portion of the pair of extending flanges displaced so that a portion of the connector protrudes from the first drain tube section. The method further includes inserting the protruding portion of the connector into one end of a second drain tube section so as to interconnect the first and second drain tube sections together, the pair of extending flanges partially received in the first drain tube section being displaced to bias outwardly against side walls of the first drain tube section.

In this embodiment, the method may further include displacing portion of the pair of extending flanges of the connector that protrudes from the first drain tube section before insertion into the second drain tube section. The pair of extending flanges may be displaced to bias outwardly against side walls of the first and second drain tube sections in still another implementation of the present method.

In accordance with yet another embodiment of the present invention, the method for assembling a modular drain system includes providing a connector having a base, an access channel to allow the liquid to enter into the base of the connector from a top of the connector, and a pair of extending flanges that extends at least partially upwardly from the base at an angle to a vertical axis of the connector to form a planar funnel into the access channel.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

We claim:

1. A modular drain system comprising:
at least two drain tube sections, each having a main body with a main channel for conveying a liquid, said main body including side walls that extend at least partially upwardly; and
a connector at least partially received in each of said at least two drain tube sections to interconnect said drain tube sections together and to allow the liquid to be conveyed therebetween, said connector having a base, at least a portion of said base including at least an arcuate cross section;
wherein said connector includes at least one extending flange that extends at least partially upwardly from said base of said connector to contact at least one of said side walls of at least one of said drain tube sections at an angle to a vertical axis of the connector to minimize relative movement between said at least two drain tube sections.

2. The modular drain system of claim 1, wherein said at least one extending flange includes a pair of extending flanges that extends upwardly from said base to contact said side walls of each of said at least two drain tube sections at an angle to the vertical axis of the connector.

3. The modular drain system of claim 2, wherein said pair of extending flanges extends upwardly from edges of said base.

4. The modular drain system of claim 2, wherein said pair of extending flanges is dimensioned to require displacement in order to be at least partially received in said at least two drain tube sections.

5. The modular drain system of claim 4, wherein said pair of extending flanges is biased outwardly against said side walls of each of said at least two drain tube sections.

6. The modular drain system of claim 1, wherein said connector includes an access channel to allow the liquid to enter into said base of said connector from a top of said connector.

7. The modular drain system of claim 6, wherein said at least one extending flange includes a pair of flanges that are positioned to form a planar funnel open to said access channel.

8. A modular drain system comprising:
at least two drain tube sections, each having a main body with a main channel for conveying a liquid, said main body including side walls that extend at least partially upwardly; and
a connector at least partially received in each of said at least two drain tube sections to interconnect said drain tube sections together and to allow the liquid to be conveyed therebetween, said connector having a base, an access channel to allow the liquid to enter into said base of said connector from a top of said connector, and at least a pair of flanges that extend upwardly from said base at an angle to a vertical axis of the connector to form a planar funnel open to said access channel.

9. The modular drain system of claim 8, wherein said pair of flanges extend upwardly to contact said side walls of at least one drain tube section.

10. The modular drain system of claim 9, wherein said pair of flanges contact said side walls of each of said at least two drain tube sections at an angle to said vertical axis of said connector.

11. The modular drain system of claim 8, wherein said pair of flanges is at least partially displaced when received in at least one of said drain tube sections.

12. The modular drain system of claim 11, wherein said pair of flanges is biased outwardly against said side walls of each of said at least two drain tube sections.

13. A modular drain system comprising:
at least two drain tube sections, each having a main body with a main channel for conveying a liquid, said main body including side walls that extend at least partially upwardly; and
a connector at least partially received in each of said at least two drain tube sections to interconnect said at least two drain tube sections together and to allow the liquid to be conveyed therebetween, said connector having a base and at least one extending flange that extends upwardly from said base, and is dimensioned to be displaced when at least partially received in at least one of said drain tube sections.

14. The modular drain system of claim 13, wherein said at least one extending flange is at least a pair of extending flanges.

15. The modular drain system of claim 14, wherein said at least a pair of extending flanges is displaced to bias outwardly against said side walls of at least one of said drain tube sections.

16. The modular drain system of claim 15, wherein said at least a pair of flanges is displaced to bias outwardly against said side walls of each of said two drain tube sections.

17. The modular drain system of claim 13, wherein said connector includes an access channel to allow the liquid to enter into said base of said connector from a top of said connector.

18. The modular drain system of claim 17, wherein said at least one extending flange is at least a pair of extending flanges positioned to provide a planar funnel open to said access channel.

19. A connector for interconnecting drain tube sections together, said connector comprising:
a base, at least a portion of said base including at least an arcuate cross section; and
at least one extending flange that extends upwardly from said base at an angle to a vertical axis of the connector to contact a side wall of a drain tube section to resist relative rotation of interconnected drain tube sections.

20. The connector of claim 19, wherein said at least one extending flange includes a pair of flanges that extend upwardly from said base at an angle to the vertical axis of the connector to contact said side walls of the drain tube sections.

21. The connector of claim 20, wherein said pair of flanges is dimensioned to require displacement in order to be at least partially received in the drain tube sections.

22. The connector of claim 19, wherein said connector includes an access channel to allow the liquid to enter into said base of said connector from a top of said connector.

23. The connector of claim 22, wherein said at least one extending flange includes a pair of flanges that are positioned to form a planar funnel open to said access channel.

24. A connector for interconnecting drain tube sections together, said connector comprising:
a base;
an access channel to allow the liquid to enter into said base of said connector from a top of said connector; and
at least a pair of flanges that extend upwardly from edges of said base at an angle to a vertical axis of the connector to form a planar funnel open to said access channel.

25. A method for assembling a modular drain system comprising:
providing a connector having a base and at least one extending flange that extends at least partially upwardly from said base, at least a portion of said base including at least an arcuate cross section;
partially inserting said connector in one end of a first drain tube section so that at least a portion of said connector protrudes from said first drain tube section; and
inserting said protruding portion of said connector in one end of a second drain tube section so as to interconnect said first and second drain tube sections together;
wherein relative movement between said first and second drain tube sections is restricted by said at least one extending flange which contacts at least one of said side walls of said first and second drain tube sections at an angle to a vertical axis of the connector.

26. A method for assembling a modular drain system comprising:
providing a connector having a base and a pair of extending flanges that extends at least partially upwardly from said base;
displacing at least a portion of said pair of extending flanges of said connector;
partially inserting said connector in one end of a first drain tube section with at least a portion of said pair of extending flanges displaced, at least a portion of said connector protruding from said one end of said first drain tube section; and
inserting said protruding portion of said connector in one end of a second drain tube section so as to interconnect said first and second drain tube sections together.

27. The method of claim 26, wherein said pair of extending flanges partially received in said first drain tube section is displaced to bias outwardly against side walls of said first drain tube section.

28. The method of claim 26, further including displacing portion of said pair of extending flanges of said connector that protrudes from said first drain tube section before insertion into said second drain tube section.

29. The method of claim 28, wherein said pair of extending flanges is displaced to bias outwardly against side walls of said first and second drain tube sections.

30. A method for assembling a modular drain system comprising:
providing a connector having a base, an access channel to allow the liquid to enter into said base of said connector from a top of said connector, and a pair of extending flanges that extends at least partially upwardly from said base at an angle to a vertical axis of the connector to form a planar funnel into said access channel;
partially inserting said connector in one end of a first drain tube section so that at least a portion of said connector protrudes from said first drain tube section; and
inserting said protruding portion of said connector in one end of a second drain tube section so as to interconnect said first and second drain tube sections together.
